(19) United States
(12) Patent Application Publication
(10) Pub. No.: US 2016/0247181 A1
(43) Pub. Date: Aug. 25, 2016

(54) Virtual currency issued upon donation of biomatter

(71) Applicant: Aaron James Rogers, Flushing, NY (US)

(72) Inventor: Aaron James Rogers, Flushing, NY (US)

(21) Appl. No.: 14/628,465

(22) Filed: Feb. 23, 2015

(51) Int. Cl. G06Q 30/02

(52) U.S. Cl. CPC G06Q 30/0215

(57) ABSTRACT

In various embodiments, a virtual currency, units of which are newly issued when a person donates blood, bone marrow, or other biomatter.

### RELATED APPLICATIONS

This application claims priority from Provisional Application No. 61/972,378, filed Mar. 30, 2014.

### FIELD OF THE INVENTION

The invention relates to a method and system for issuing and managing a virtual currency. Particularly, the invention relates to a virtual currency whose units are issued when a person donates or agrees to donate blood, plasma, bone marrow, vital organs, or other such biomatter. Specifically, the invention relates to a novel technique for creating units of a virtual currency upon a person's donation of (or promise to donate) biomatter, which currency units are stored on a digital computer system and openly transferable and/or tradable for other currencies, goods or services, or other valuable consideration.

### BACKGROUND OF THE INVENTION

At present there is a variety of virtual currencies that are issued, administered, and traded among individuals and institutions on interconnected computer networks. These currencies exist entirely as bits of digital information stored on servers, personal computers, and mobile computing devices. They may be exchanged for cash, traded for other virtual currencies, spent to purchase real or virtual goods and services, or held as investments. Each virtual currency is either administered by a central authority or governed by a set of well-established rules.

As with all currencies, a rapid increase in the amount of a virtual currency in circulation would lead to inflation and a resultant loss of credibility by the issuing body. Conventionally, the supply of virtual currencies is limited by protocol to preserve the value of each individual unit of currency and to ensure the integrity of the currency system. In the case of “crypto-currencies” such as Bitcoin and Litecoin, new units of currency are created via the execution of a processor-intensive algorithm, the complexity of which limits the rate at which new units can be generated. The total global quantity of such units of currency may also be limited by design; further supporting the value of each individual unit of currency.

In the case of other virtual currencies, such as those commonly used in online multiplayer computer games like World of Warcraft, new units are typically spawned by some in-game action performed by the game player, such as virtual mining or farming. Systemic and human limits on the rate at which such actions can be performed regulate the speed at which new units of currency can be created and thus their overall supply in the game world. Still other virtual currencies have been pre-issued upon inception of the currency system (i.e., the digital currency “XRP”) or upon the performance of a specific act by an individual operating a computer (i.e., “beenz”).

Common to all these virtual currencies is that their individual units are not generated by any per-se useful act that confers a substantial tangible benefit outside the digital realm of the computer.

Every day in the United States, 41,000 blood donations are required to keep pace with the demand from accident victims needing transfusions, patients undergoing treatment for disease, and scientists engaged in medical research. Despite the fact that over a third of U.S. citizens are eligible to donate blood, less than 10% of them donate annually, with rates in the UK and Canada even lower.

An individual blood donor must wait a minimum of 56 days between donations, limiting the rate at which any one person can contribute to the blood supply. And because donated blood must generally be used within 42 days of collection, the blood supply is further limited by spoilage. Thus, spikes in demand caused by disasters and war can create shocks in the system, necessitating ad hoc collection efforts and hasty logistical action. Even in times of tranquility, maintaining the nation's blood supply is a constant effort requiring enormous investment in promotion, administration, and infrastructure.

In addition to blood, there are many other types of donatable biomatter that convey life-altering benefits. Blood plasma can be administered to patients suffering from burns and trauma. Bone marrow and stem cells can be used to treat blood cancers and immune deficiencies. An individual who registers to become an organ donor can potentially save the lives of several victims of accident and disease. Donations of eggs and sperm create families that would otherwise never have existed, and hair donations bring comfort and dignity to persons suffering from alopecia areata, cancer, and severe burns.

Common to all these types of biomatter is that the rate of donation, and thus the aggregate supply of each of these categories of biomatter, are naturally limited by the rate at which the human body regenerates itself, by the effectiveness of the collection methods employed in the art, and by the overall level of medical demand for the biomatter.

### SUMMARY OF THE INVENTION

The method and system of this invention center around the innovative concept of issuing a new unit of virtual currency to an individual upon their donation of blood, plasma, bone marrow, or other such biomatter at an established facility such as a blood bank or hospital. It is an object of the present invention to provide a method and system for utilizing the donation of human biomatter to invoke issuance of units of virtual currency. It is also an object of the present invention to provide a method and system for allocating, storing, and transacting such units of currency between donors, retailers, financial institutions, and investors. Another object of this invention is to provide a method to encourage the donation of human biomatter by offering valuable incentive in the form of virtual currency. Another object of this invention is to provide a method to promote the stability of said currency by tethering the issuance of new units to the physical act of donation, which is naturally limited by demand, the human body, and the state of the art. Finally, it is an object of this invention to provide a method for issuing a new virtual currency that offers financial benefits as both a store of value and as an opportunity for investment for third parties. These and other objects of the invention will be apparent to those skilled in the art from the description that follows.

The present invention advances the art of virtual currencies by tying their issuance to the fulfillment of a global humanitarian need. Systemic limits on the rate of human biomatter donation impose a corresponding limit on the issuance of new units of currency, which in turn promotes stability and trust in the integrity of the currency. And trade and investment in the currency by third-parties may serve to increase its nominal value, thus incentivizing donation of lifesaving biomatter by potential donors who anticipate receiving new units of the currency.

### BRIEF DESCRIPTION OF THE DRAWINGS

FIG. 1: Illustrates the basic communications infrastructure required to implement the invention and the relationships between the various parties.

FIG. 2: Illustrates a typical computer system architecture.

FIG. 3: Illustrates various graphic interfaces that may be used to implement the essential features of the invention.

FIG. 4: Depicts a sample keycode voucher that the donor may redeem to receive a newly-issued unit of the virtual currency.

FIG. 5: Flowchart illustrating the essential steps involved in issuing a new unit of the virtual currency.

FIG. 6: Flowchart illustrating the essential steps taken when an account holder purchases an existing unit of the virtual currency.

FIG. 7: Flowchart illustrating the essential steps taken when an account holder sells a unit of the virtual currency.

### DETAILED DESCRIPTION OF THE INVENTION

### Biomatter-Based Virtual Currency

In embodiments of a biomatter-based virtual currency, individual donors of blood, bone marrow, and other types of useful biomatter are issued new units of currency as a result of their donations. Such units of currency represent units of value and are analogous, though not equivalent, to legal tender. In some embodiments, units of biomatter-based virtual currency are represented by virtual coins. Following issuance, these units of currency may be held by the donor, sold to third parties for cash, donated to charity, traded for alternative units of virtual currency, or spent on good and services sold by sellers that have agreed to accept these units of virtual currency as payment.

### Issuing New Units of Biomatter-Based Virtual Currency

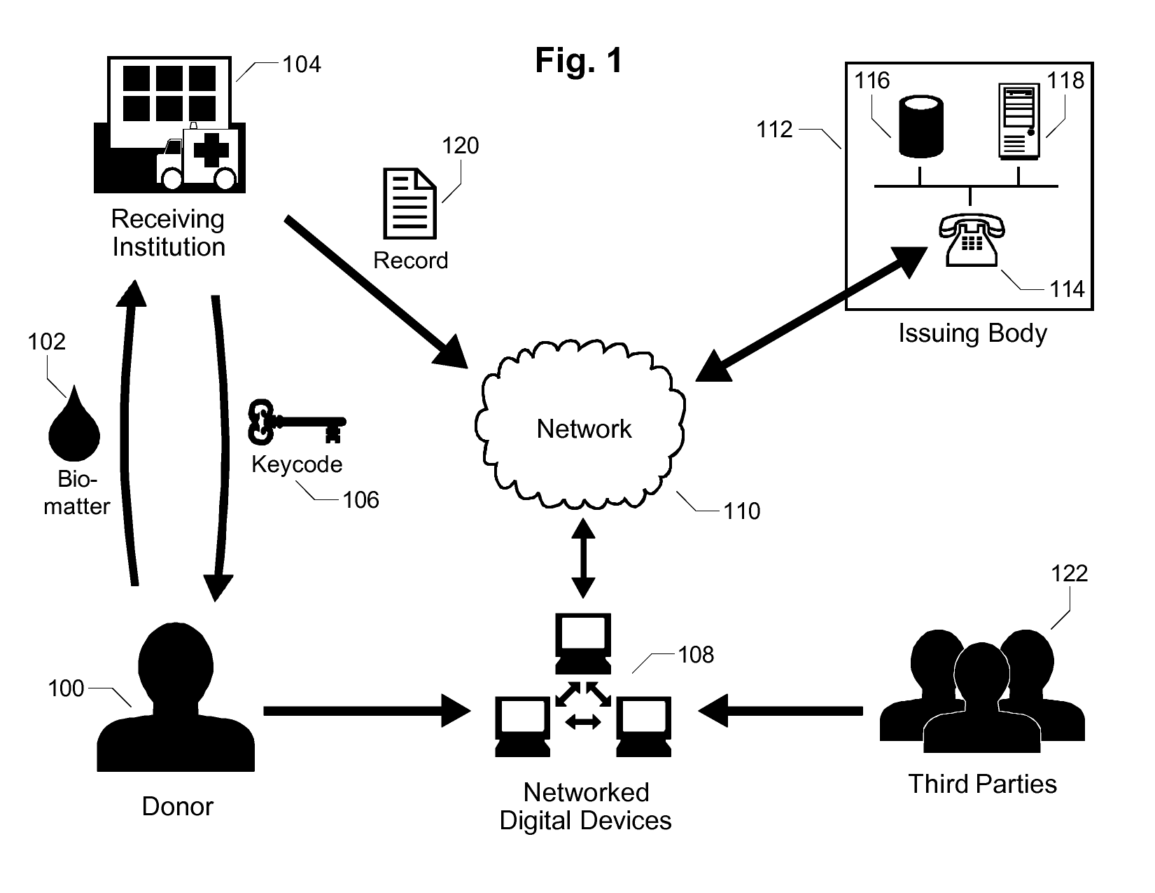

FIG. 1 illustrates the basic relationship between the parties involved in the issuance of a new unit of biomatter-based virtual currency. In some embodiments, an established and appropriately-licensed facility 104 performs an initial screening process in which the individual's eligibility to donate is verified. If eligible, the donor 100 visits the facility and the donor's biomatter 102 is collected pursuant to standard practices and in accordance with all applicable laws and regulations. When the collection process is complete, the recipient facility offers to the donor the opportunity to receive a newly-issued unit of virtual currency.

In some embodiments of this method, the facility records the following information about the donor: name, e-mail address, phone number, and the type of donation. The facility transmits this information 120 digitally via a secure data connection across an interconnected computer network 110 (such as the Internet) to the issuing body's own centralized computer system 112, which registers a new account in the donor's name (if necessary) and increments the amount of virtual currency in the account. The issuing body then notifies the donor via a standard text message or e-mail that a new unit of currency has been issued to the donor's account. Varying amounts of currency may be issued depending upon the type of donation (ex: more currency may be issued to the donor for a bone marrow donation than for a hair donation).

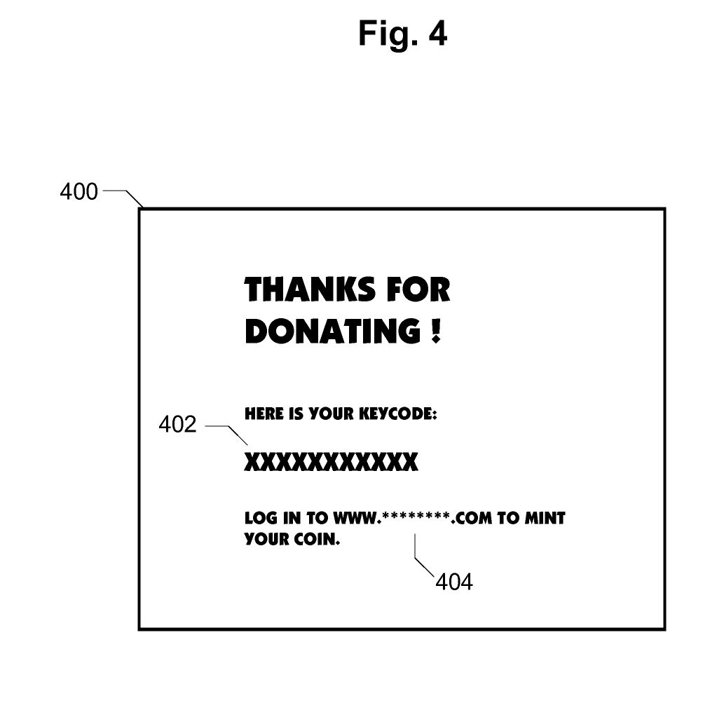

In other embodiments of this method, the issuing body 112 generates a list of serial numbers or keycodes which each correspond to a yet-unissued unit of virtual currency and conveys a subset of these keycodes to the receiving facility 104 in advance of the donation. A different series of keycodes may be generated to correspond to each type of biomatter, and they keycodes are stored in a database on the issuing body's computer systems. Upon completion of the donation, the facility presents the donor with information that includes registration instructions and one or more of the keycodes 106. This information may be presented in physical form, for example on a printed card (FIG. 4), or it may be conveyed to the donor electronically via a standardized delivery method such as e-mail or text message, or via a customized application running on the donor's cell phone, tablet, or personal computer. Upon receiving the web address 404 and keycode 402, the donor may connect to the issuing body's computer system over a network 108.

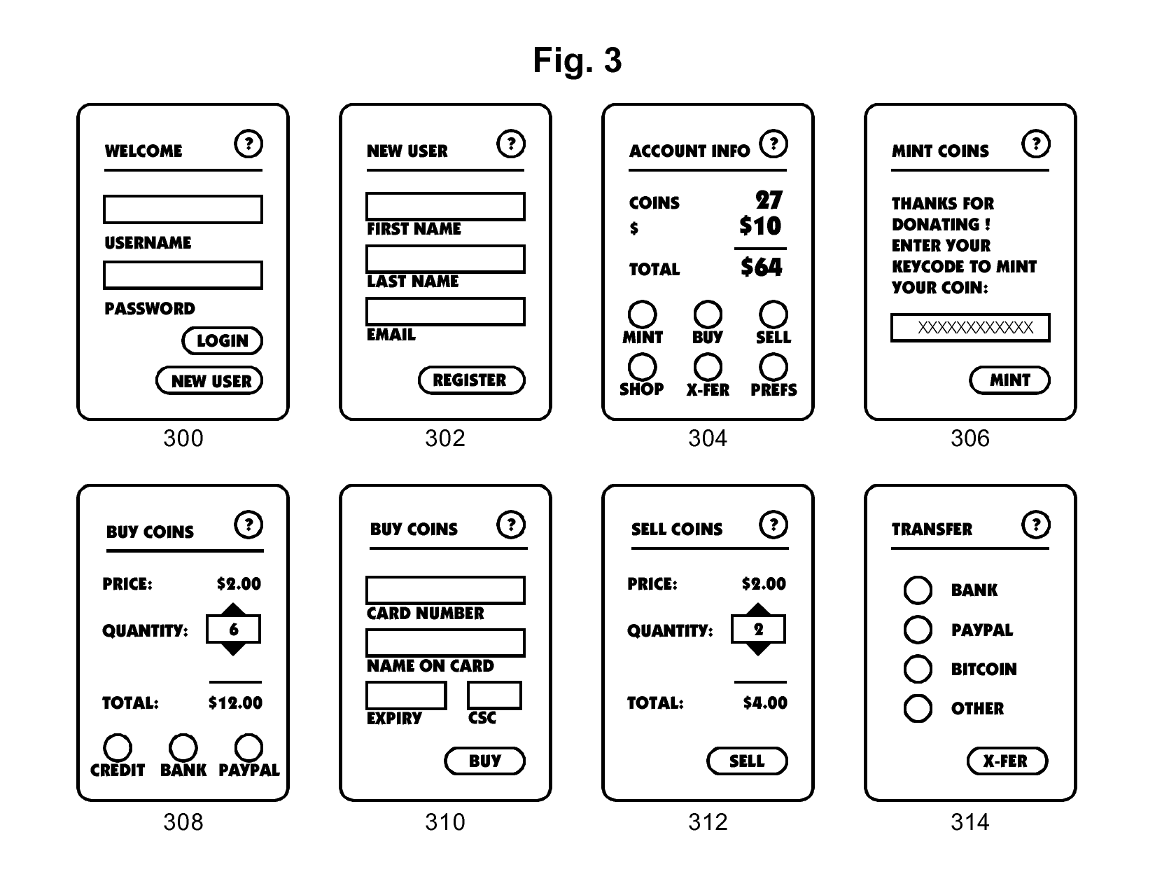

FIG. 3 illustrates some embodiments of the graphic user interfaces that may be presented to the donor to implement this method. Upon visiting the web address provided by the receiving facility, the donor is presented with a typical web-based secure login screen 300. If the donor has already registered an account with the issuing body, the donor enters a username and password to log in. If the donor is not yet a registered user, the donor clicks a “New User” button and is asked to provide basic identifying information to create a new account 302. Upon logging into the account, the donor is presented with a screen depicting the quantity of virtual currency in the account as well as the amount of any cash held in the account (proceeds from the prior sale of units of virtual currency) 304.

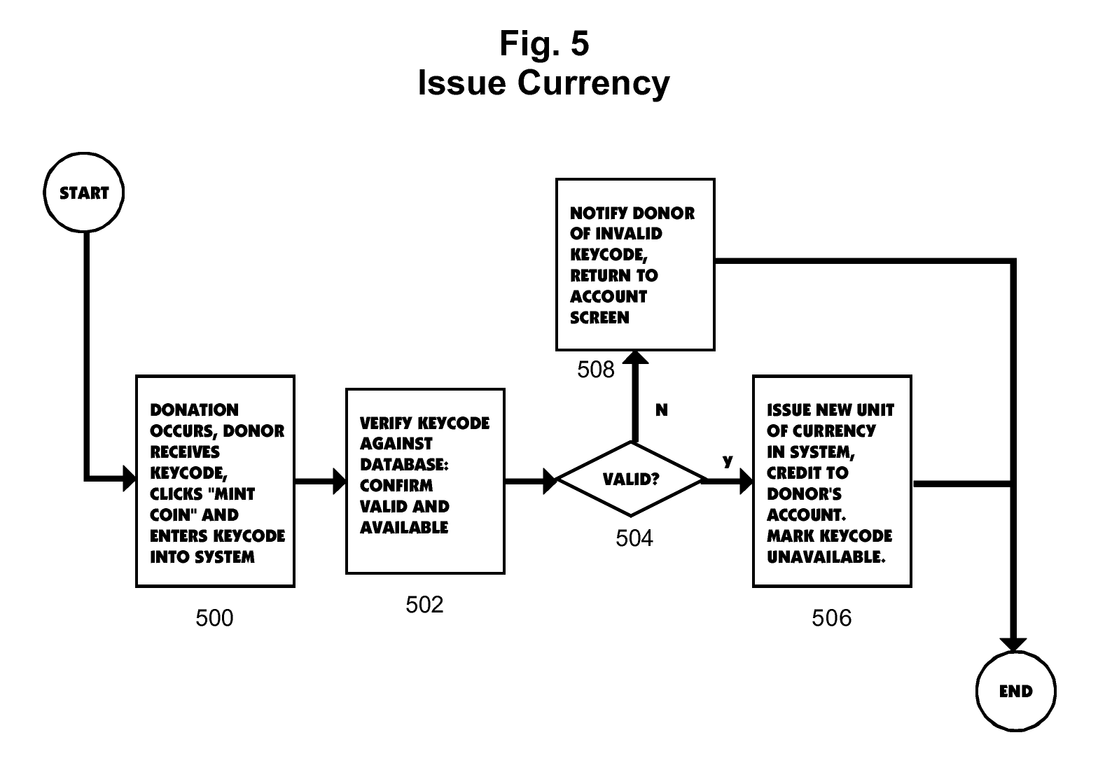

FIG. 5 is a flowchart illustrating an embodiment of the method for issuing a new unit of currency. If the donor wishes to redeem a newly-issued unit of currency, a screen is presented allowing the donor to enter a keycode 306. The issuing body checks the keycode against the database 502 to ensure that it has not yet been redeemed. If the keycode has already been redeemed or is otherwise invalid 508, the donor is notified and returned to the account overview interface. If the keycode is valid, the issuing body then issues new currency that uniquely corresponds to the keycode 506, credits the new currency to the donor's account, and updates the database to mark the keycode as no longer available. As above, varying amounts of currency may be issued depending upon the type of biomatter donation.

In some embodiments, the donor's account information and the corresponding units of virtual currency may be stored centrally as digital data on the issuing body's own computer server systems 118. Any further transactions involving the currency, including transfer, sale, and conversion, are carried out by the issuing body via this centralized computer system upon the request of the donor.

In some embodiments, the units of virtual currency may be stored as digital data on the donor's personal computer, tablet, or mobile device 108 by means of a custom-developed computer application created by the issuing body. In this case, the issuing body's central computer systems 112 would operate as a clearing facility to verify the donor's keycode 106 and to digitally tender a new unit of virtual currency to the donor's device. Any subsequent transactions involving the unit of currency would be executed between the donor and the transaction counterparty 122 according to protocols embedded within the issuing body's computer application.

In some embodiments, the rate at which an individual donor may receive newly-issued units of virtual currency can be limited by protocol to the maximum rate at which a person may donate the underlying type of biomatter. For example, for medical reasons individuals may donate blood no more than once every 56 days, thus a donor's account may be prohibited from accruing newly-issued units of virtual currency arising from blood donations at a rate exceeding once in any given 56-day period. This prevents the fraud that might occur should an individual gain access to multiple keycodes and attempt to redeem them.

In some embodiments, units of virtual currency may be marked with a built-in “expiration date,” on which date the unit of currency would be removed from circulation and the cash value of the currency deposited into the owner's account. This is analogous to the limited storage-life of all types of biomatter and would serve to limit the amount of the virtual currency in circulation should it be necessary or proper to do so.

### Purchasing and Selling Units of Biomatter-Based Virtual Currency

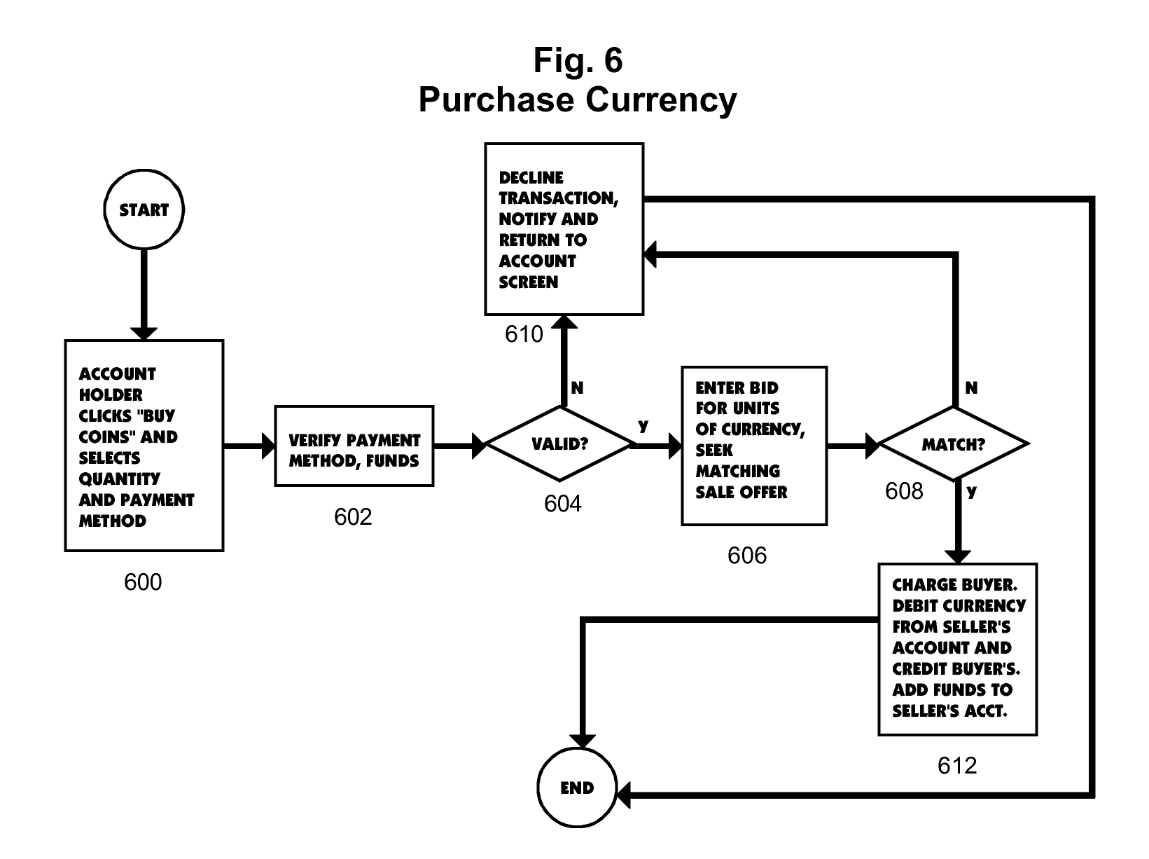

In some embodiments, after issuance by the issuing body, units of virtual currency held in a donor's account may be sold to third-parties 122 who also have accounts on the issuing body's computer system. These third-parties may be other donors or they may be individuals or institutions interested in purchasing units of the virtual currency. FIG. 6 is a flowchart illustrating an embodiment of the method of purchasing a unit of virtual currency as invoked by a third-party. From the account overview screen 304, the purchaser clicks “Buy” and is directed to enter the quantity and payment method (ex: credit card, PayPal, etc.) 308. The issuing body verifies that the purchaser has funds available 604 to cover the cost of the purchase 602. If funds are not available, the would-be purchaser is notified that the transaction was declined and is redirected to the account overview screen 610. If funds are available, the issuing body's computer systems invoke a purchase-and-sale transaction 606.

In some embodiments, such sale-and-purchase transactions may be executed via a market system whereby the issuing body's networked computer servers would attempt to match open bids to purchase units of currency against open offers to sell, with the price of the currency determined by bid and ask prices, which are generally determined by aggregate supply and demand 608. If a match is found, the transaction is executed and the parties' accounts updated to reflect the exchange 612.

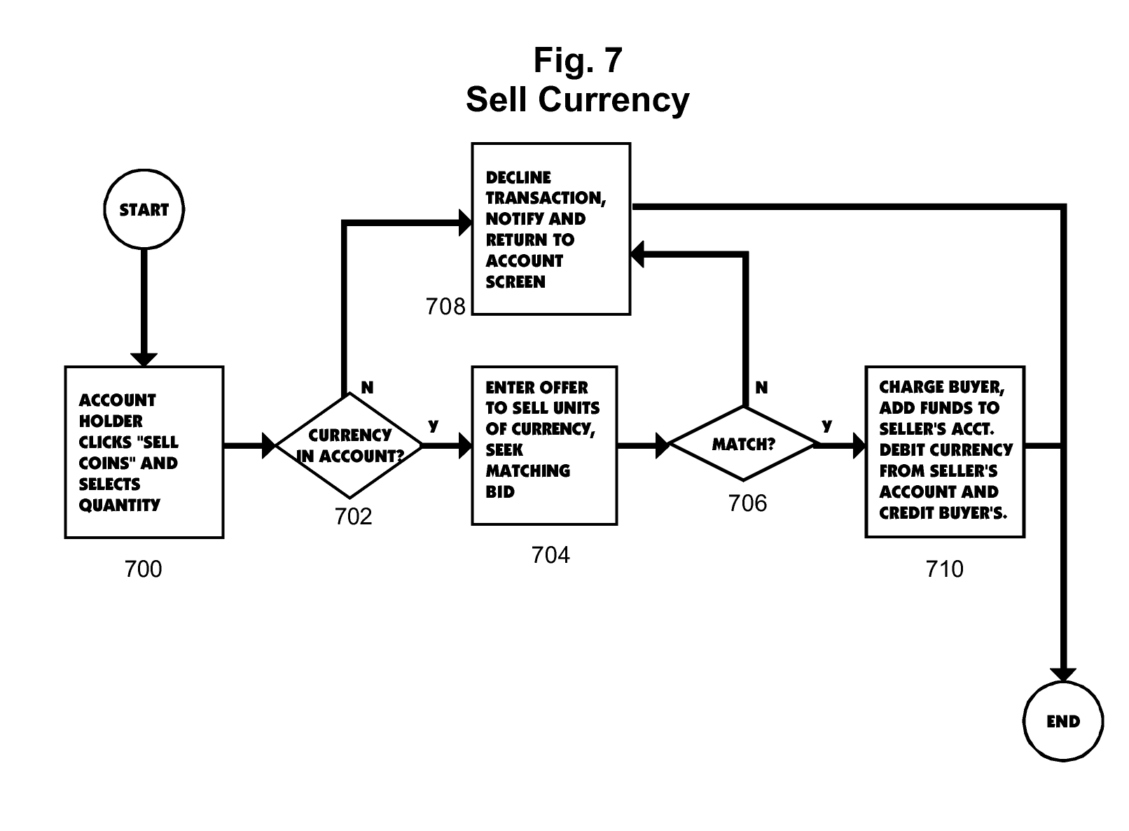

FIG. 7 is a flowchart illustrating an embodiment of the corresponding method of selling a unit of virtual currency as invoked by an account holder. From the account overview screen 304 the account holder clicks “Sell,” is directed to a screen that displays the dollar value of the units of virtual currency, and is prompted to enter the quantity for sale 312. The issuing body verifies that the quantity of currency exists in the seller's account 702. If the seller's account does not contain sufficient currency the transaction is declined 708. If the currency is available, the issuing body's computer systems invoke a purchase-and-sale transaction 704 as described in the foregoing paragraph.

In some embodiments, the various methods and interfaces described above may be implemented using a network of digital computing devices. FIG. 1 depicts an example of a network environment through which various embodiments may operate. In one embodiment, the keycodes 106, records 120, the interfaces depicted in FIG. 3, and other information necessary to implement the invention may be transmitted using a wide area packet-based network 110 such as the Internet. Alternatively, such data may be transmitted through satellite or cellular networks, wireless networks, private networks, paging networks, and other electronic networks.

In some embodiments, the interfaces illustrated in FIG. 3 may be implemented as web pages accessible via standard web browsers like Google Chrome, Mozilla Firefox, Apple's Safari, and Microsoft's Internet Explorer. Such web pages may be encoded using, without limitation, standards such as Hypertext Markup Language (HTML), Extensible Markup Language (XML), Java and/or Javascript, Asynchronous Javascript and XML (AJAX), Common Gateway Interface (CGI) Script, Flash, PHP, and any other technologies commonly employed in the art.

In some implementations, these web pages may be held on a data store consisting of network-attached hard disk drives 116. This data store may also contain a database that holds account information such as names, e-mail addresses, units of currency and cash held in account, and any other information necessary to implement the methods described above. Such information may be stored as data objects, which comprise sequences of digital data embodied in a file, database, or record. These objects may be encoded in a variety of low-level and high-level formats, including raw binary data, text (ASCII, SGML, HTML), bitmaps (JPEG, TIF, BMP, GIF), vector-graphics formats, audio, video, or any combination thereof. These data objects may also include executable program code. The data store 116 may comprise one or more separate or interconnected object-oriented or relational databases that encode information in the form of records or files stored on physical hard disk drives, solid state drives, optical drives, tape drives, or any other storage medium suited to the long-term recording of digital data. Industry standards such as SQL may be used to implement this functionality.

In some embodiments, web pages and data objects may be made accessible by a network-addressable computer system that comprises one or more physical computer servers 118 connected to the Internet by a series of standard switches, routers, and gateway devices 114. Data transmission across this network may be performed using standard protocols including, without limitation, Transfer Control Protocol/Internet Protocol (TCP/IP), Hypertext Transfer Protocol (HTTP), File Transfer Protocol (FTP), Point-to-Point Protocol (PPP), Serial Line Internet Protocol (SLIP), Secure Sockets Layer (SSL), or any combination thereof. Conventional security methods, such as public/private key encryption, may be employed to ensure the privacy of the data transmissions.

In some embodiments, the interfaces depicted in FIG. 3 may be implemented as a custom application that resides as an executable program on an account holder's networked digital device 108. Such devices may include personal desktop or laptop computers, mobile devices such as tablets or smartphones, personal digital assistants, or gaming devices such as consoles and handhelds that are capable of communicating over a network and downloading and executing custom applications.

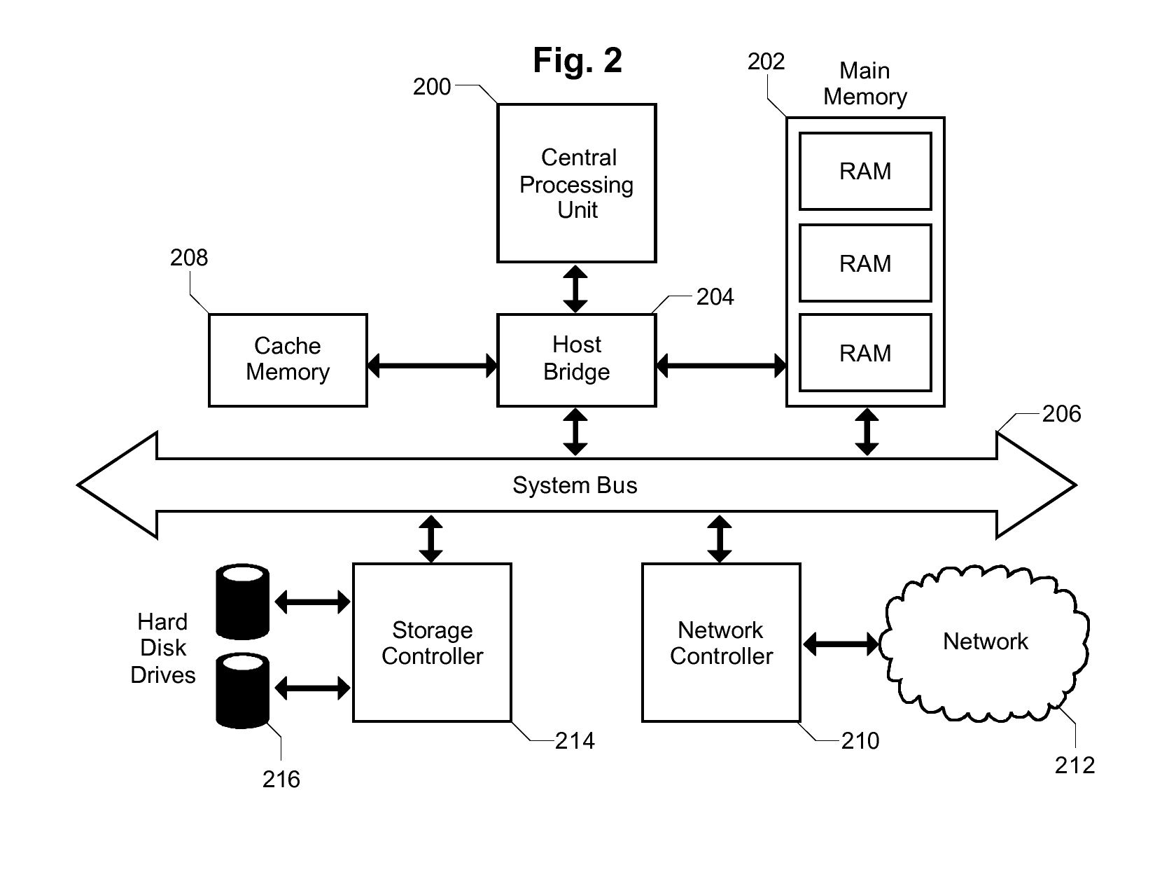

FIG. 2 illustrates an example of a computing system that may be used to implement a networked digital device 108 or server 118. In some embodiments, a general-purpose central processor 200 accesses program code and data stored temporarily in main memory 202, which access may be accelerated through the use of high-speed cache memory 208. This central processor may comprise one or more computing cores and may implement a variety of instruction sets including Intel x86/x64, ARM, MIPS, PowerPC, SPARC, and other instruction set architectures common to the art. Memory access may be controlled by a host bridge 204, and the processor and main memory may interface with other portions of the computing system by means of a standardized system bus 206 such as PCI, PCI Express, InfiniBand, AGP, and HyperTransport.

In some embodiments, executable program code and data may be stored on one or more internal hard disk drives 216, solid state drives, flash drives, or other permanent storage media, which interface with the system bus by means of a storage controller 214 that may implement industry standards such as SATA, SCSI, IEEE 1394, IDE, Fibre Channel, and Thunderbolt. Access to local and wide-area networks 212 may be implemented by means of a network controller 210 which interfaces with other portions of the computing hardware across the system bus 206. Standard network communication protocols and topologies such as Ethernet, TCP/IP, IEEE 802.11 a/b/g/n, CDMA, GSM, 4G LTE, and Asynchronous Transfer Mode (ATM) may be used to manage data transfer between devices on the network.

Operation of the computing system may be controlled by a software-based operating system that manages disk and memory access, CPU utilization, program execution, networking, and input/output operations between the central components of the computing system and peripheral components such as human interface devices, I/O ports, printers, removable media devices, and expansion cards. Interoperability between software and hardware components may generally be achieved via an abstraction layer that makes use of low-level driver software. A variety of industry-standard networked operating systems may be used to implement the aforementioned features, including Linux, BSD, UNIX variants such as Solaris and AIX, Microsoft Windows, Apple's Mac OS X and iOS, Google's Android, QNX, and BlackBerry OS. In some embodiments, the application software and/or operating system software may be implemented via low-level firmware or via an application-specific integrated circuit (ASIC).

### Miscellaneous

This disclosure and the following claims incorporate all variants and substitutions that might be attempted by a person having ordinary skill in the art. The design drawings and specifications herein are merely illustrative and are not intended to limit the scope of the disclosure.

Features from any embodiment described herein may be combined with features from any other embodiment without departing from the scope of this disclosure.

The words “the,” “a,” and “an” herein are generally intended to mean “one or more” unless otherwise indicated.

What is claimed is:

1. A method, comprising:
receiving, at a server, a request to issue a new unit of virtual currency, wherein the request is sent by an individual who has donated biomatter, and wherein the request includes a keycode that uniquely identifies the new unit of currency;
crediting the account of the individual with a newly-issued unit of virtual currency and marking the keycode as redeemed in a database.

2. The method of claim 1 further comprising receiving requests from account holders to buy and sell units of virtual currency in exchange for legal tender via a computerized system that allows the price of the currency to fluctuate according to supply and demand.

3. The method of claim 2 further comprising receiving requests from account holders in possession of virtual currency to use said currency to purchase goods and services from participating retailers and to exchange said currency for other types of virtual currency, debiting and crediting the amount of currency on account as appropriate.

4. The method of claim 2 further comprising enforcing a maximum rate at which individual donors can accrue new units of currency that is equivalent to the maximum rate at which the underlying type of biomatter may be donated.

5. A method, comprising:
receiving, at a server, a request to issue a new unit of virtual currency, wherein the request is sent by a facility that has received biomatter donated by an individual, and wherein the request includes information that identifies the individual;
creating an account in the individual's name as necessary and crediting the account with a newly-issued unit of virtual currency.

6. The method of claim 5 further comprising receiving requests from account holders to buy and sell units of virtual currency using legal tender via a computerized exchange system that allows the price of the currency to fluctuate according to supply and demand.

7. The method of claim 6 further comprising receiving requests from account holders in possession of virtual currency to spend said currency on goods and services from participating retailers and to exchange said currency for other types of virtual currency, debiting and crediting the amount of currency in account as appropriate.

8. The method of claim 6 further comprising enforcing a maximum rate at which individual donors can accrue new units of currency that is equivalent to the maximum rate at which the underlying type of biomatter may be donated.

9. An apparatus comprising:
one or more central processing units coupled to random-access memory containing program instructions that are executed by the processors, the instructions operating the processors to:
receive, through a network, a request to issue a new unit of virtual currency, wherein the request includes digital information that uniquely distinguishes the recipient of the new unit of currency;
verify, by accessing a digital database, the validity of the request;
create a new account for the recipient in a digital database if necessary and credit the account with a newly-issued unit of virtual currency.

10. The apparatus of claim 9, wherein the program instructions in memory further operate the processors to:
maintain a list of keycodes in a digital database to record which units of virtual currency have been issued;
receive requests from account holders to buy and sell units of virtual currency in exchange for legal tender via a computerized system that allows the price of the currency to fluctuate according to supply and demand;
receive requests from account holders in possession of virtual currency to use said currency to purchase goods and services from participating retailers and to exchange said currency for other types of virtual currency, debiting and crediting the amount of currency on account as appropriate.
